(19) United States
(12) Patent Application Publication
(10) Pub. No.: US 2006/0003285 A1
(43) Pub. Date: Jan. 5, 2006

(54) Articulation navigation equipment for dental surgery

(76) Inventors: Yasuo Kotsuchibashi, Kanagawa (JP); Takako Kotsuchibashi, Kanagawa (JP); Sunao Kotsuchibashi, Kanagawa (JP); Atsushi Kotsuchibashi, Kanagawa (JP); Makoto Kotsuchibashi, Kanagawa (JP)

Correspondence Address: JORDAN AND HAMBURG LLP, 122 EAST 42ND STREET, SUITE 4000, NEW YORK, NY, 10168, US

(21) Appl. No.: 10/523,628

(22) PCT Filed: May 26, 2004
(86) PCT No.: PCT/JP04/07539

§ 371 Date: Feb. 4, 2005

(30) Foreign Application Priority Data
Jun. 12, 2003 (JP) 2003-197454
Mar. 25, 2004 (JP) 2004-088244
Mar. 30, 2004 (JP) 2004-098414

(51) Int. Cl. A61C 19/04

(52) U.S. Cl. 433/68

(57) ABSTRACT

The articulation-navigation equipment for dental surgery includes the measuring parts which take basically the relation between the patient's face and teeth are arranged; the bite forks which is bite in the oral cavity of the patient and fixes the bite plane; the positioning wire for camper, extending to right and left ears which measures and takes the camper plane C; the orbital pointing pin which measures and takes one of orbital; the pointing rod for median line which measures and takes the median line M; the orbital points which measures and takes the right and left orbital on the frankfult plane F; the pointing rod for bite plane which measures and takes the bite plane O; and the screw which is screwed on the nut for adjusting the height, supporting the support base. Therefore, it can measure and take aesthetic point and basic point quickly in a short time in spite of the face bow without practice, and it has a small size and lightweight.

### BACKGROUND OF THE INVENTION

The present invention relates to an articulation-navigation equipment for dental surgery which gets the relation between a patient's face and teeth using a face bow to offer the prosthetic dentistry thing for patients from dentist. It is desired the dentistry medical treatment is performed that the mouth which is observed using a face bow in dentist's position and the mouth which equips an occlusion machine and is observed in the position of the dental technician who manufactures a prosthetic dentistry object using the face bow gotten is carried out with the same concept. Specially, the present invention relates to an articulation-navigation equipment for dental surgery in spite of the face bow with the difficult operation and can offer the prosthetic dentistry object which is satisfied with aesthetic and functionally.

The conventional dentist measures the patient's face using the face bow (not shown) in order to offer the prosthetic dentistry object. The main point for measuring the patient's face is a median line M, a frankfult plane F, a camper plane C, a bite plane O and the like.

The face bow which is measured the patient's face is given to the dental technician which manufactures the prosthetic dentistry object. In this case, the face bow does not have the same concept between the mouth which is observed using a face bow in dentist's position and the mouth which is observed in the position of the dental technician who manufactures a prosthetic dentistry object. The skill was needed for the handling of the face bow until it resulted in the common concept. In addition, it is not the structure of the face bow which can measure the aesthetic point of patient's face. In spite of measuring completely in the physical distribution stage given the face bow taken from dentist to dental technician, the face bow is large, packing is complicated and screw etc. loosens so that it may be told for inaccurate information. When the prosthetic dentistry object is manufactured in the state that the inaccurate take is not noticed, since the manufactured prosthetic dentistry object does not suit for patient, it will start from measurement and taking of patient by dentist again.

FIG. 1 shows an example of the disclosed measuring for the patient's face. The dentist usually takes the relation between the patient's face and teeth using the face bow. In the disclosure of Japanese Patent Laid-Open Publication No. 10-295707, it is the example of take using the determination equipment of the esthetic bite plane. The reference numeral is explained, and unknown numeral is presumed. It is comprised of the face bow 1, determination wire 5 for aesthetic bite plane, orbital support rod 6, bite fork 7, plate 8 for bite plane, both pupils 10, median line rod 13 and attachment 14. As shown in Figures, each parts of the determination equipment of the aesthetic bite plane as the face bow is arranged as covering the face so that it is impossible to observe the relation between face and teeth squarely.

FIG. 2 shows a perspective view showing the way in which a positioning device for aesthetic bite plane in FIG. 1 is installed in a bite device. The dental technician installs the face bow transfer which takes the relation between the patient's face and teeth by the determination equipment for aesthetic bite plane in the bite device in order to manufacture the prosthetic dentistry object. The bite device which is installed the determination equipment for the aesthetic bite plane is observed squarely, it is comprised of the face bow 1 which is installed the bite device 12, wire 5, orbital support rod 6, bite fork 7, plate 8 for bite plane, both pupils 10, median line rod 13 and attachment 14 so that each part of the determination equipment of the aesthetic bite plane as the face bow covers the bite plane, it is impossible to observe squarely and it is hard to manufacture the aesthetic prosthetic dentistry object.

In addition, the dentist takes the relation between the patient's face and teeth by various face bow which the skills is needed for handling. The dental technician who manufactures the prosthetic dentistry object using the face bow after taking, it is installed in the bite device with full adjustment or semi-adjustment. For the dental activity, it is desired that the oral cavity that is observed by dentist and by dental technician have equality on common concept. It is ideal that the model which is installed face bow taken the bite in the designated bite device is placed under the same situation. When the taken face bow is installed in the bite device and the dental technician manufactures the prosthetic dentistry object, since the measuring parts of the face bow aesthetic do not have such structure which shows the points of the face and they cover the face so that it is hard to observe, the dental technician manufactures the prosthetic dentistry object for the median line and tip part of central incisor through a trial and error process by the light of nature and experience based on the relation between patient's face and teeth.

As mentioned above, the face bow which is taken the relation between the patient's face and teeth by dentist is needed the skills. The measuring parts in the face bow cannot express the aesthetic point structurally, and it covers the front side of the face. Each face's point which is the base model cannot be observed in the disclosed determination equipment for the aesthetic bite plane squarely. It is difficult to observe the median line, frankfult plane and camper plane as necessary points on the face in the disclosed face bow and alternative measuring equipment. The bite plane is covered so that it is hard to observe because of the horseshoe-shaped bite fork. If right height of jaw is measured, right median line and tip of central incisor cannot be measured correctly. If it can be taken, the aesthetic point cannot be determined.

In addition, the oral cavity of patient is taken precisely for manufacture the denture base for patient by dentist. The biteplate is manufactured based on taking the detail impression. The biteplate is manufactured in order to manufacture the denture base, and the bite is taken. After that, the plaster cast is attached to the bite device. The dentist needs to decide the arrangement of maxillary front teeth by the tip of central incisor as based on the median line of the patient's face. Although the various types of equipment including the determination equipment for the position for the median line and arrangement axis for prosthetic tooth in order to support the arrangement of maxillary front teeth by dentist, the denture manufacturing equipment and the like are disclosed, they cannot arrange on the basis of patient's craniofacial anchoring point and relation of position for taking the bite. In this case, the positioning equipment for center position, the front teeth arrangement equipment for molding the prosthetic tooth, the arrangement equipment for molar teeth and the like are prepared, they are changed for any purpose so that they can manufacture with combining the ready-made parts uniformly, however there are many time to try to remanufacture the denture base in order to match the denture base to delicate feeling of patient and make patient feel more functional.

Accordingly, it is an object of the present invention to provide an articulation-navigation equipment for dental surgery which is a small size and lightweight. It is another object of the present invention to provide an articulation-navigation equipment for dental surgery that can operate quickly in a short time in spite of the face bow without practice and can measure and take the aesthetic point and basic point. It is still another object of the present invention to provide an articulation-navigation equipment for dental surgery that the dental technician who manufactures the prosthetic dentistry object can decide median line, right and left orbital, one of orbital, frankfult plane, camper plane and bite plane physically on the model that the taken articulation-navigation equipment for dental surgery is attached without covering by the measuring parts of the articulation-navigation equipment for dental surgery. It is still another object of the present invention to provide an articulation-navigation equipment for dental surgery that includes a bite fork which does not cover the bite plane and can decide the right median line from the position of the right and left central incisors. It is still another object of the present invention to provide an articulation-navigation equipment for dental surgery that can operate without changing the value of the take. It is still another object of the present invention to provide an articulation-navigation equipment for dental surgery that can manufacture the aesthetic and functional prosthetic dentistry object easily when the articulation-navigation equipment for dental surgery is attached to the bite device.

It is further object of the present invention to provide an articulation-navigation equipment for dental surgery that can arrange the maxillary front teeth-prosthetic tooth and maxillary molar teeth-prosthetic tooth from a theoretical standpoint on observing basic point with relation between the patient's head capsule and face, face, facial features and the like which is positioned by the articulation-navigation equipment for dental surgery and can manufacture the whole or partial aesthetic and functional denture base.

The present invention is understood to encompass embodiments which include all or only a portion of the above objects, features and advantages which, unless recited in claims defining the invention, are understood not to limit interpretation of such claims. The above, and other objects, features and advantages of the present invention will become apparent from the following description read in conjunction with the accompanying drawings, in which like reference numerals designate the same elements.

It is to be expressly understood, however, that the drawings are for the purpose of illustration and description only, and are not intended as a definition of the limits of the invention.

### DISCLOSURE OF THE INVENTION

Accordingly, the articulation-navigation equipment 100 for dental surgery, capable of operating quickly in a short time in spite of a face bow without practice and manufacturing the aesthetic and functional prosthetic dentistry object easily, includes measuring parts which take basically the relation between the patient's face and teeth are arranged; bite forks 71 which is bite in the oral cavity of the patient and fixes the bite plane; a positioning wire 51 for camper, extending to right and left ears which measures and takes the camper plane C; an orbital pointing pin 61 which measures and takes one of orbital; a pointing rod 41 for median line which measures and takes the median line M; orbital points 421 which measures and takes the right and left orbital on the frankfult plane F; a pointing rod 43 for bite plane which measures and takes the bite plane O; a screw 21 which is screwed on a nut 26 for adjusting the height, supporting a support base 80; and a screw for fixation of the nut 26.

In addition, in claim 2, the articulation-navigation equipment for dental surgery according to claim 1, wherein the articulation-navigation equipment for dental surgery 100 further includes the bite forks 71 as one of the measuring parts, providing at a support shaft integrally, having a large size (L), middle size (m) and small size (S) corresponding to the size of the oral cavity of the patient, and applying a modeling compound to both sides of the bite forks 71 to remain the teeth mark of the patient when the bite forks 71 are used; and the support shaft attached fixedly to a support base 80 and a support base 81.

Furthermore, in claim 3, the articulation-navigation equipment for dental surgery according to claim 1, wherein the articulation-navigation equipment for dental surgery 100 further includes detachable bite forks 72 as one of the measuring parts provided at right and left sides, exchanging the bite fork 72 whenever the patient changes for hospital infection prevention, the bite forks 72 supported by the support shaft which is attached detachably by screws 721, 811, further including a nut 722 which is formed at the bite forks 72, inserting the screw 721 therein, and a screw hole 723 which is formed in the shape of rectangle, capable of fine adjusting to the horizontal direction so as to fine adjust the direction on the support shaft; the bite forks 72 having the large size (L), middle size (m) and small size (S), corresponding to the oral cavity of the patient and applying a modeling compound to both sides of the bite fork 71 to remain the teeth mark of the patient when the bite forks 71 are used; and the support shaft which is attached fixedly to the support bases 80, 81.

Furthermore, in claim 4, the articulation-navigation equipment for dental surgery according to claim 1 or 3, wherein the articulation-navigation equipment for dental surgery 100 further includes detachable bite spoon 73 as one of the measuring parts provided at right and left sides, exchanging the bite spoon 73 whenever the patient changes for hospital infection prevention, the bite spoon 73 supported by the support shaft which is attached detachably by the screws 721, 811, further includes the nut 722 which is formed at the bite spoon 73, inserting the screw 721 therein, and the screw hole 723 which is formed in the shape of rectangle, capable of fine adjusting to the horizontal direction so as to fine adjust the direction on the support shaft; the bite spoon 73 having the large size (L), middle size (m) and small size (S), corresponding to the oral cavity of the patient and applying a modeling compound to both sides of the bite spoon 73 to remain the teeth mark of the patient when the bite spoon 73 are used; and the support shaft which is attached fixedly to the support bases 80, 81.

Furthermore, in claim 5, the articulation-navigation equipment for dental surgery according to any of claims 1 to 4, wherein the articulation-navigation equipment for dental surgery 100 further includes a positioning wire 51 for camper which measures and takes camper plane C as one of the measuring parts; a plurality of fixing shafts which fixes the positioning wire for camper 51 and the positioning wire 51 for camper which are provided at the right and left sides of the support base, the fixing shaft 54 passing through the support base 80 and installing to move upward and downward, and fixing by screws 55 which are provided the same number of the fixing shaft 54 at the support base 80; tip portions of the right and left positioning wires 51 for camper including hanging rings 52 which hangs the ears and fixing rings 53; and the fixing ring 53 is provided at a place which hangs to a location pin 93 of the bite device when the prosthetic dentistry object is manufactured, one of the positioning wires 51 for camper being fixed by the screw via a hole which is provided at the fixing shaft 54.

Furthermore, in claim 6, the articulation-navigation equipment for dental surgery according to any of claims 1 to 4, wherein the articulation-navigation equipment for dental surgery 100 further includes an orbital pointing pin 61 as one of the measuring parts which is installed fixedly by a screw 63 which passes through the hole of an orbital point shaft 62, measuring and taking one of the orbital, having one end of the orbital point shaft 62 which is formed in the shape of a ball so as to support rotatably in the orbital range an engagement part 65 which is formed at the support base 80, capable of engaging the ball part of the orbital point shaft 62 therewith; and a screw 64 which fixes the ball part which is engaged with the engagement part 65 at a predetermined position in the orbital range.

Furthermore, in claim 7, the articulation-navigation equipment for dental surgery according to any of claims 1 to 4, wherein the articulation-navigation equipment for dental surgery 100 further includes a pointing rod 41 for median line, right and left orbital points 421 and a pointing rod 43 for bite plane as the measuring parts which are installed; the pointing rod 43 for bite plane which passes through a holding part 49 for the bite plane which is formed in the shape of a cross and tube and is fixed by the screw 47; the holding part 49 for the bite plane which is supported fixedly by a support pole 410 which is inserted into the a support pipe 623 and is fixed by a screw 411; the support pipe 623 having a ball part at one side thereof, engaging with the support base 40; a screw 45 which fixes the support pipe 623 at a inclined position; the support base 40 having a backside thereof which is formed in the shape of a mountain so as to engage and move slidably; a concave part 82 which is formed at a support base 81; a graduation 84 which is formed at the support base 81, pointing to the position; and a screw 643 which fixes the support base 40 with the support base 81 at a determined position.

Furthermore, in claim 8, the articulation-navigation equipment for dental surgery according to any of claims 1 to 4 and 7, wherein the articulation-navigation equipment for dental surgery 100 further includes a pointing rod 41 for median line, right and left orbital points 421 and a pointing rod 43 for bite plane as the measuring parts which are installed; the pointing rod 41 for median line which passes through an upper part of the holding part 49 for the bite plane which is formed in the shape of a cross and tube and is fixed by the screw 46; the holding part 49 for the bite plane which is supported fixedly by a support pole 410 at a lower part thereof; the screw 46 which adjusts and fixes the upward and downward movement of the pointing rod 41; the screw 45 which adjusts and fixes the inclination of the pointing rod 41 for median line; and a screw 643 which adjusts the horizontal movement of the pointing rod 41 to be moved the support base 40.

Furthermore, in claim 9, the articulation-navigation equipment for dental surgery according to any of claims 1 to 4, 7 and 8, wherein the articulation-navigation equipment for dental surgery 100 further includes the pointing rod 41 for median line, the right and left orbital points 421 and the pointing rod 43 for bite plane as the measuring parts which are installed; the orbital points 421 which further includes a screw so as to hold and fix with passing through the orbital pointing rod 42; the orbital pointing rod 42 which is held and fixed by a screw 481 in the state that it passes through an orbital holding part 48 which is formed in the shape of a T-letter and formed of a sleeve; the orbital holding part 48 which is supported by the support pole 41; the holding part 49 for the bite plane which supports the support pole 41 which is fixed by the screw 46; the screw 46 which adjusts and fixes the upward and downward movement of the orbital point 421; the screw 45 which adjusts and fixes the inclination of the orbital point 421; and the screw 643 which adjusts the horizontal movement of the orbital point 421 to be moved the support base 40.

Furthermore, in claim 10, the articulation-navigation equipment for dental surgery according to any of claims 1 to 9, wherein the articulation-navigation equipment for dental surgery 100 further includes a fixing base 20 as the measuring parts which is used when the articulation-navigation equipment 100 for dental surgery is supported fixedly and the taking state is confirmed or it is installed in the bite device, which is formed in the shape of a C-letter, further including a pair of screws 23 for fixing; a plurality of screw holes 24 which is formed corresponding to the shape of the bite device; a fixed concave part 22, capable of engaging fixedly the nut 26 for adjustment to height of the articulation-navigation equipment 100 for dental surgery and a fixed plug 25, which is formed in the shape of a mountain, fixing the nut 26 for adjustment to height in cooperation with the fixed concave part 22.

Furthermore, in claim 11, the articulation-navigation equipment for dental surgery according to any of claims 1 to 4 and 7 to 9, wherein the articulation-navigation equipment for dental surgery 100 further includes a front teeth arrangement plate 431 for prosthetic tooth as the measuring parts including a suitable inclination which three teeth as front teeth-prosthetic tooth of the upper jaw can be adhered by a wax centering around the patient's median line M, having a curvature part corresponding to the curvature of the patient's front teeth of the upper jaw; a supported rod which supports the curvature part of the front teeth of the upper jaw, capable of using in spite of the pointing rod 43 for the bite plane with exchanging, passing through the holding part 49 for the bite plane and being fixed by the screw 47 and having the large size (L), middle size (m) and small size (S) so as to correspond to the curvature portion of the patient's front teeth.

Furthermore, in claim 12, the articulation-navigation equipment for dental surgery according to any of claims 1 to 4 and 7 to 9, wherein the articulation-navigation equipment for dental surgery 100 further includes a bite plane plate 432 for molar teeth and prosthetic tooth as the measuring parts which is installed, including a plane plate with the large size), middle size (m) and small size (S) corresponding to a biteplate of the oral cavity of the patient so as to be able to arrange the molar teeth-prosthetic tooth of the patient's front teeth of the upper jaw and a supported rod which supports the plane plate, capable of using in spite of one of the pointing rod 43 and the front teeth arrangement plate 431 for prosthetic tooth, passing through the holding part (49) and being fixed by the screw 47; and a biteplate with the prosthetic arrangement for the front teeth of the upper jaw, capable of arranging the bite of the molar teeth-prosthetic tooth of the upper jaw thereto on the basis of the prosthetic arrangement for the front teeth of the upper jaw decided by front teeth arrangement plate 431 after the bite plane plate 432 with the articulation-navigation equipment 100 is installed in the fixing base 20.

### BRIEF DESCRIPTION OF THE DRAWINGS

FIG. 1 is a front view of an example for conventional measuring the patient's face showing a first embodiment of the present invention;

FIG. 2 is a perspective view showing the way in which a positioning device for aesthetic bite plane in FIG. 1 is installed in a bite device;

FIG. 3 is a perspective view of articulation-navigation equipment for dental surgery;

FIG. 4 is a diagram of basic plane of main points measuring patient's face showing a first embodiment of the present invention;

FIG. 5 is a perspective view of a pointing rod for median line, right and left orbital points and a pointing rod for bite plane;

FIG. 6 is a perspective view of a of a pointing rod for bite plane and a support base which supports a support base;

FIG. 7 is a cross sectional view of a orbital pointing pin;

FIG. 8 is a drawing for main measuring point showing the way in which patient's face is looked in front;

FIG. 9 is a diagram of observing the face from front direction showing the way in which an articulation-navigation equipment for dental surgery is used;

FIG. 10 is a perspective view of a fixing base;

FIG. 11 is a perspective view showing the way in which an articulation-navigation equipment for dental surgery is fixed by a fixing base;

FIG. 12 is a diagram for measuring side parts of the main points of patient's face;

FIG. 13 is a side view showing the way in which an articulation-navigation equipment for dental surgery which is fixed via a fixing base installed in a bite device;

FIG. 14 is a perspective view of a bite fork which screws in a support shaft showing a second embodiment of the present invention;

FIG. 15 is a perspective view of a bite spoon which screws in a support shaft showing a third embodiment of the present invention.

FIG. 16 is a schematic explanation view showing a fourth embodiment of the present invention;

FIG. 17 is an explanation view of a bite fork showing the fourth embodiment of the present invention;

FIG. 18 is a reference view of a bite spoon showing the fourth embodiment of the present invention;

FIG. 19 is an explanation view for attachment of a positioning wire for camper showing the fourth embodiment of the present invention;

FIG. 20 is an explanation view of a circumferential part around a rod showing the fourth embodiment of the present invention;

FIG. 21 is an explanation view a circumferential part around another rod showing the fourth embodiment of the present invention;

FIG. 22 is an explanation view a circumferential part around other rod showing the fourth embodiment of the present invention;

FIG. 23 is an explanation view at an installing state showing the fourth embodiment of the present invention;

FIG. 24 is an explanation view of supported part showing the fourth embodiment of the present invention;

FIG. 25 is an explanation view in use showing the fourth embodiment of the present invention;

FIG. 26 is an explanation view showing a fifth embodiment of the present invention;

FIG. 27 is an explanation view at an attachment state showing a fifth embodiment of the present invention;

FIG. 28 is an explanation view showing a sixth embodiment of the present invention;

FIG. 29 is an explanation view at an attachment state showing a sixth embodiment of the present invention; and

FIG. 30 is an explanation view in use showing a sixth embodiment of the present invention.

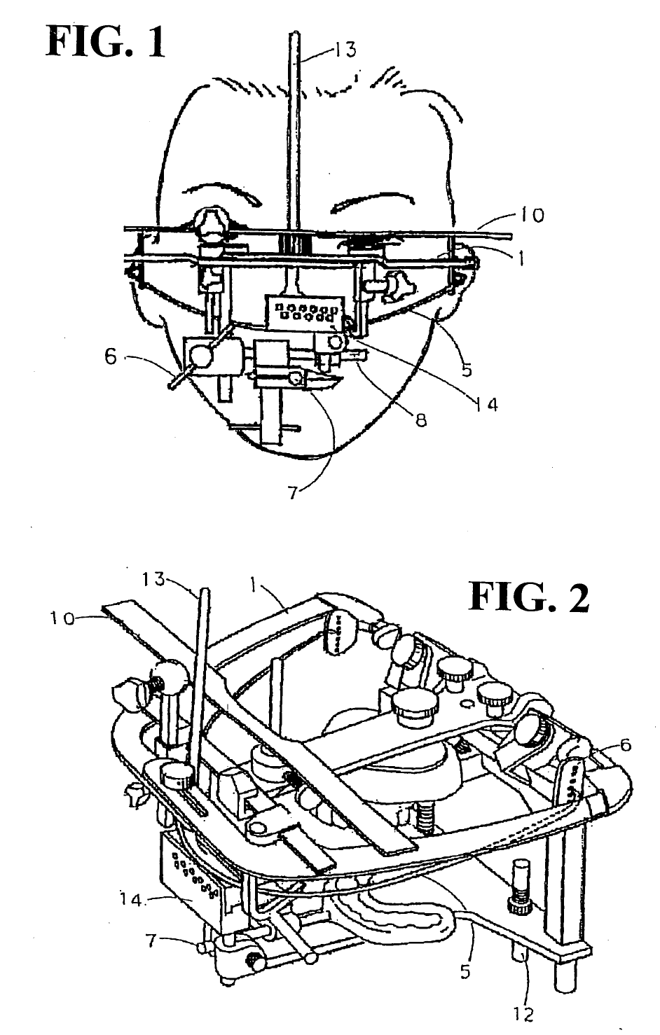

### DETAILED DESCRIPTION OF THE PREFERRED EMBODIMENTS

Preferred embodiments of the present invention are described in more detail below referring to the accompanying drawings.

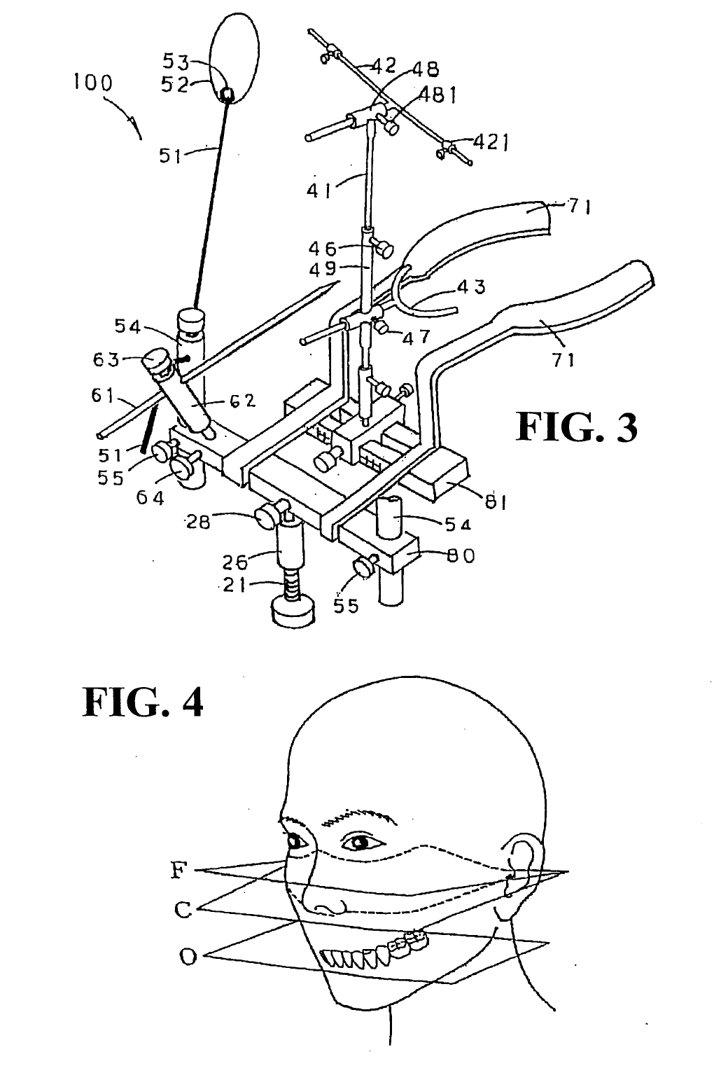

An understanding of the present invention may be best gained by reference in FIGS. 3 to 13. The reference number 100 shows an articulation-navigation equipment for dental surgery that can operate quickly in a short time in spite of the face bow without practice and can manufacture the aesthetic and functional prosthetic dentistry object easily when the articulation-navigation equipment for dental surgery is attached to the bite device.

FIG. 3 illustrates a perspective view of the articulation-navigation equipment for dental surgery of the present invention.

For the articulation-navigation equipment 100 for dental surgery, the measuring parts which take basically the relation between the patient's face and teeth are arranged. The measuring parts is comprised of right and left bite forks 71 which are bite in the oral cavity of the patient and fix the bite plane; a positioning wire 51 for camper, extending to right and left ears which measures and takes the camper plane C; an orbital pointing pin 61 which measures and takes one of orbital; a pointing rod 41 for median line which measures and takes the median line M; right and left orbital points 421 which measures and takes the right and left orbital on the frankfult plane F; and a pointing rod 43 for bite plane which measures and takes the bite plane O.

In the articulation-navigation equipment 100 for dental surgery, the bite forks 71 as one of the measuring parts are provided at right and left sides thereof. The bite forks 71 are provided integrally with the support shaft and supported by the support shaft. The support shaft is fixed to support bases 80, 81 in this embodiment. The dentist inserts the bite forks 71 into the oral cavity of the patient so as to be the measuring basis with relation between patient's face and teeth and positions fixedly the bite plane O. The bite fork 71 is provided each other separately so that it does not cover the bite plane O because it is not formed in the horseshoe-shaped. The right and left bite forks 71 are fixed with bite along with the bite plane O until the measuring and taking about each relational point of the patient's face and teeth finishes. The shape of the bite fork 71 is formed with a large size (L), middle size (m) and small size (S) so as to correspond with the size of the oral cavity of the patient. When the bite forks 71 are used, the modeling compound is applied to both sides of the bite fork 71 so as to remain the teeth mark of the patient.

For the articulation-navigation equipment 100 for dental surgery, the positioning wire 51 for camper which measures and takes camper plane C as one of the measuring parts and a fixing shaft 54 which fixes the positioning wire for camper 51 are provided at the right and left sides of the support base 80. The plurality of the fixing shafts 54 may be provided at the right and left sides of the support base 80 via space (the plurality of the fixing shafts 54 are not shown in Figure). The fixing shaft 54 passes through the support base 80 and equipped to move upward and downward, and it is fixed by screws 55 which are provided the same number of the fixing shaft 54 at the support base 80. The tip portions of right and left positioning wires for camper 51 includes hanging rings 52 which hangs the ears, and fixing rings 53. The fixing ring 53 is provided at a place which hangs to a location pin 93 of the bite device when the prosthetic dentistry object is manufactured. One of the positioning wires 51 for camper is fixed by the screw via the hole which is provided at the fixing shaft 54.

Dentist measures and takes camper plane C as one of the measuring basis to measure relation between the patient's face and teeth. Using the positioning wire 51 for camper which is installed in the articulation-navigation equipment 100 for dental surgery, it extends to ears in order to use the arbitrary condyle axis point of the face and takes. The hanging ring 52 hangs ears, camper plane C is measured and taken by the extended positioning wire 51 for camper via cheek. When the prosthetic dentistry object is manufactured, the fixing ring 53 is the important part to fix to the location pin 93 of the bite device with hooking.

FIG. 7 illustrates a cross sectional orbital pointing pin shown in FIG. 3.

The articulation-navigation equipment 100 for dental surgery is installed an orbital pointing pin 61 as one of the measuring parts. The orbital pointing pin 61 which is taken one of the orbital is fixed by the screw 63 which passes through the hole of the orbital point shaft 62. For the orbital pointing pin 61, one end of the orbital point shaft 62 is formed in the shape of a ball so as to support rotatably in the orbital range. The support base 80 is formed an engagement part 65 so as to engage the ball of the orbital point shaft 62. The ball engaged with the engagement part 65 is fixed by the screw 64 at a predetermined position in the orbital range.

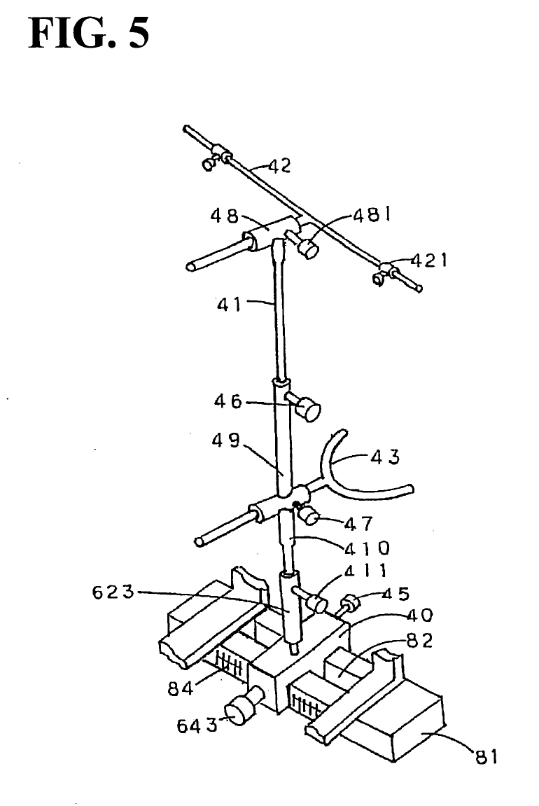

FIG. 5 illustrates a perspective view of pointing rod for median line, right and left orbital points and pointing rod for bite plane shown in FIG. 3.

The articulation-navigation equipment 100 for dental surgery is attached the pointing rod 41 for median line, the right and left orbital points 421 and the pointing rod 43 for bite plane as a measuring parts therein.

The pointing rod 41 for median line is supported by holding part 49 for the bite plane which is formed in the shape of a cross and tube, and it is fixed by the screw 46. The holding part 49 for the bite plane is supported by the support pole 410. The support pole 410 is supported by the support part 623. One side of the support part 623 is formed in the shape of a ball rotatably. The ball part is embedded in the support base 40, and it includes the screw 45 so as to fix at the predetermined position during rotate freely. The upward and downward movement of the pointing rod 41 for median line is fixed by adjustment of the screw 46. The backside of the support base 40 is formed in the shape of a mountain so as to engage and move slidably, and it is fixed by a screw 643. The support base 40 is attached detachably.

The right and left orbital points 421 include a screw so as to hold and fix with passing through the orbital pointing rod 42 (the orbital point 421 may not be installed when the orbital pointing rod 42 supports). The orbital pointing rod 42 is held and fixed by the screw 481 in the state that it passes through the orbital holding part 48 which is formed in the shape of a T letter and formed of a sleeve. The orbital holding part 48 is supported by the support pole 41. The support pole 41 is supported by the holding part 49 for the bite plane and is fixed by the screw 46. The upward and downward for the orbital pointing rod 42 is fixed by the adjustment of the screw 46 of the bite plane holding part 49. The orbital pointing rod 42 moves on the support base 40 horizontally.

The pointing rod 43 for the bite plane is supported with passing through the holding part 49 for the bite plane and is fixed by the screw 47. The holding part 49 for the bite plane is supported by the support pole 410. The support pole 410 is supported by the support part 623. The pointing rod 43 for the bite plane moves on the support base 40 horizontally.

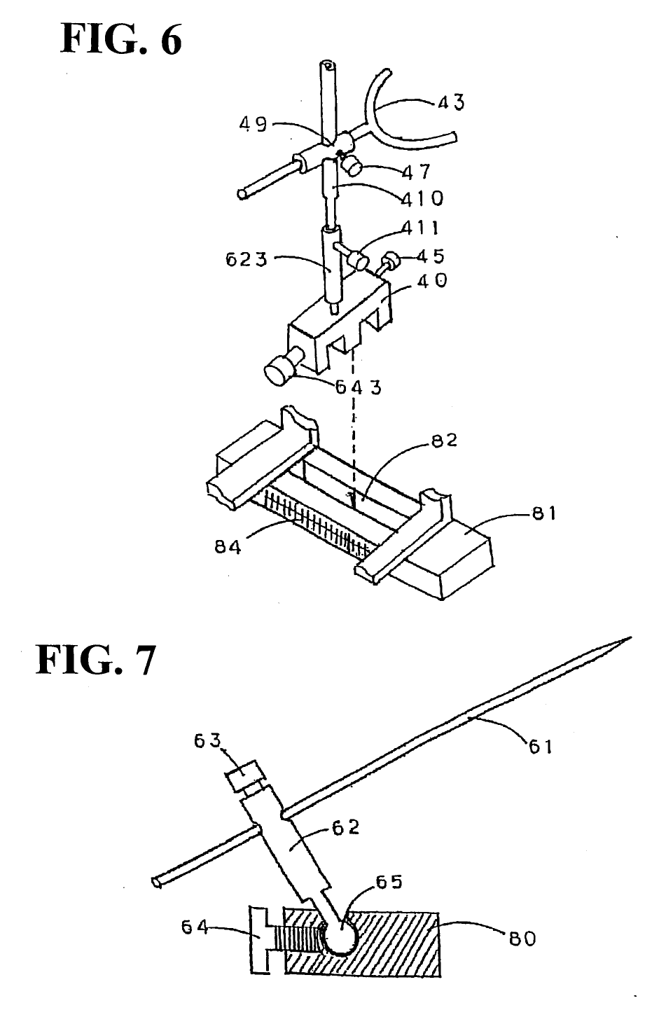

FIG. 6 illustrates a perspective view of a support base of the pointing rod for bite plane and a support base support the support base shown in FIG. 5.

The pointing rod 43 for bite plane is fixed by the screw 47 which is provided at the holding part 49 for the bite plane. The bite plane holding part 49 is fixed by a screw 411 which is supported by the support pipe 623 which supports fixedly the support pole 410. One end of the support pipe 623 is formed in the shape of a ball and engages with the support base 40. The inclined support pipe 623 is fixed by the screw 45. The back of the support base 40 is formed in the shape of a mountain so as to move slidably and horizontally and engages with the concave part 82 of the support base 81. When the support base 40 is positioned, it fixed by the screw 643. The graduation 84 is provided to the support base 81. The upward and downward movement of the pointing rod 43 for bite plane is adjusted by screwing down the screw 411. After the screw 47 is screwed down, the pointing rod 43 for the bite plane can move and rotate freely. When the support base 40 is removed from the support base 81, the graduation 84 is recorded, and the recorded graduation 84 is brought the original position back.

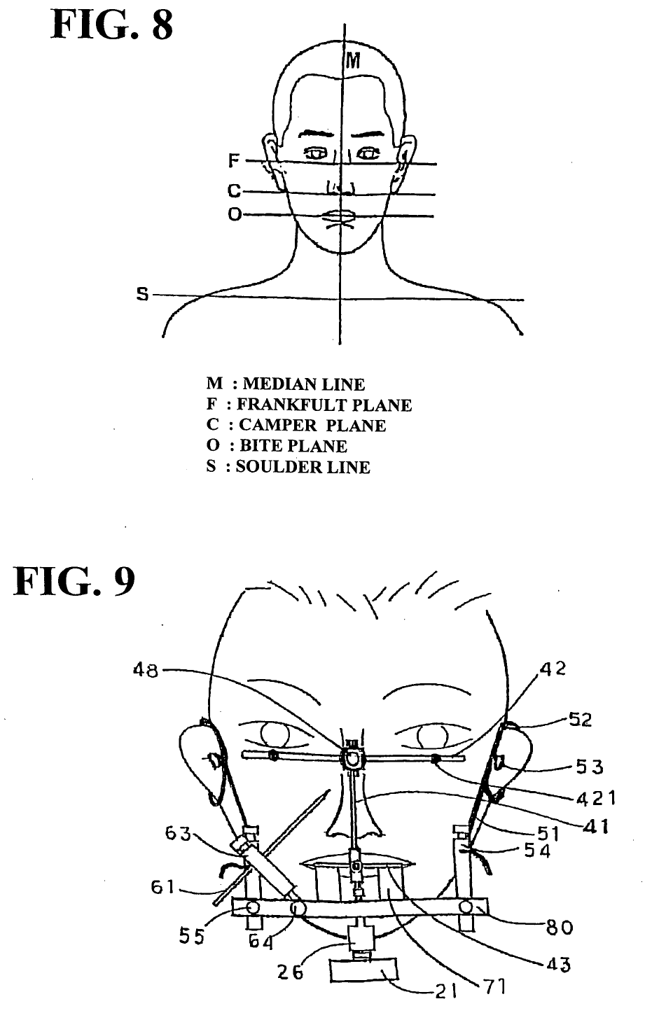

FIG. 8 is a drawing for main measuring point showing the way in which patient's face is looked in front.

The dentist measures and takes the patient's face in order to supply the prosthetic dentistry object for patient. The main measuring points of the patient's face are median line M, frankfult plane F, camper plane C and bite plane O. The shoulder line is shown in reference. The dental technician who manufactures the prosthetic dentistry object based on the articulation-navigation equipment 100 for dental surgery which measures and takes patient's face by dentist measures the right median line of the face on measuring the balance to facial appearance (see THE JOURNAL OF DENTAL TECHNOLOGY, EXTRA ISSUE, p 131, published on Jun. 25, 2004 in Japan). In specially, the vertical axis arrangement including the bite plane O and median line M gives influences. The balance to the face is decided to the large part in order, and it is considered the arrangement of teeth, gum and teeth sequentially.

FIG. 9 illustrates a diagram of observing the face from front direction showing the way in which an articulation-navigation equipment for dental surgery is used;

When patient is measured by the articulation-navigation equipment 100 for dental surgery, patient bites the bite fork 71 after it is inserted into the right and left sides of patient's oral. After that, bite plane O is measured and taken; the median line M is measured and taken by pointing rod 41 for the median line; right and left orbital points on the frankfult plane F is measured and taken by pointing rod 43 for bite plane; one of orbital is measured and taken by the orbital pointing pin 61; and camper plane C is measured and taken by positioning wire 51 for camper. The articulation-navigation equipment 100 for dental surgery which takes the patient's face is given to the dental technician in order to manufacture the prosthetic dentistry object. The dental technician installs the articulation-navigation equipment 100 for dental surgery in the bite device. The oral cavity that is observed by dentist and by dental technician has equality on common concept without covering the face by the measuring parts when the articulation-navigation equipment 100 for dental surgery is observed squarely.

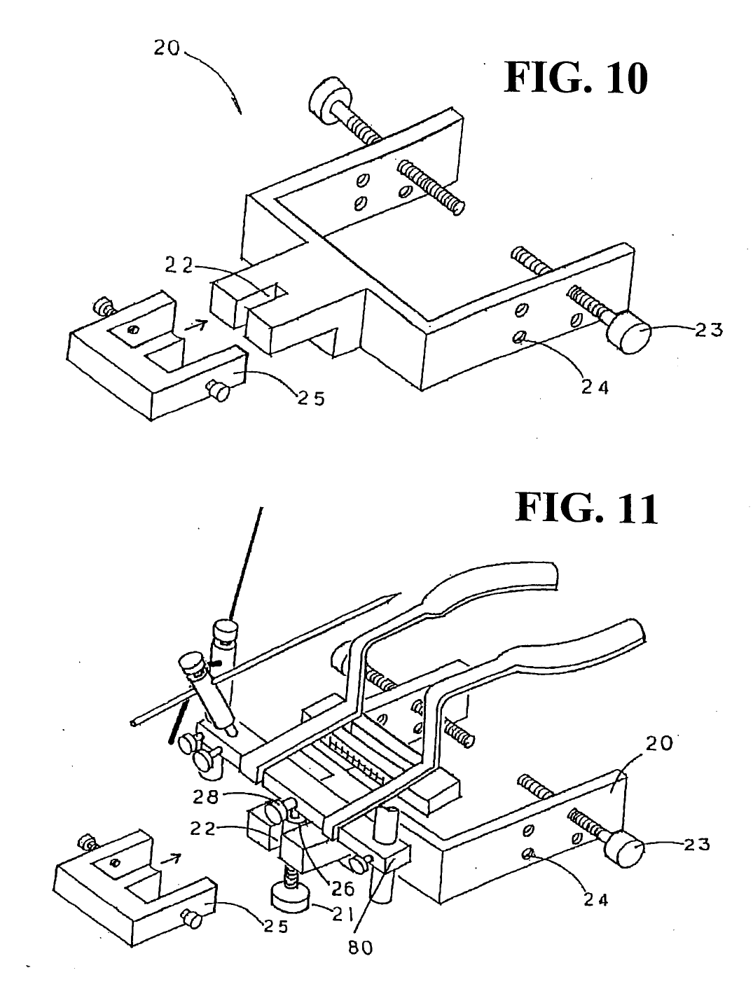

FIG. 10 illustrates a perspective view of the fixing base.

The fixing base 20 is comprised of a pair of screws 23 for fixing fixed to the bite device when the articulation-navigation equipment 100 for dental surgery is installed in the bite device, a plurality of screw holes 24 which is formed corresponding to the shape of the bite device, a fixed concave part 22 which is provided the articulation-navigation equipment 100 for dental surgery, capable of engaging fixedly the nut 26 for adjustment to height and a fixed plug 25 which is formed in the shape of a mountain, fixing the nut 26 for adjustment to height in cooperation with the fixed concave part 22. The nut 26 which supports the support base 80 is screwed on the screw 21. One end of the nut 26 is formed in the shape of a ball, and it is engaged with a center portion of the back of the support base 80. Since the nut 26 rotates because of the ball part, the screw 28 presses and fixes at the preferred position.

FIG. 11 illustrates a perspective view showing the way in which an articulation-navigation equipment for dental surgery is fixed by a fixing base. The articulation-navigation equipment 100 for dental surgery is installed the fixing base 20 one of the measuring parts. The fixing base 20 is used when the articulation-navigation equipment 100 for dental surgery is supported fixedly and the taking state is confirmed or it is installed in the bite device. For the fixing base 20 which is formed in the shape of a C-letter, it is composed of the pair of screws 23 for fixation, the screw holes 24 which are formed corresponding to the shape of the bite device, a fixed concave part 22 which is provided the articulation-navigation equipment 100 for dental surgery, capable of engaging fixedly with the nut 26 for adjustment to height. Also the fixed plug 25 is formed in the shape of a mountain, fixing the nut 26 for adjustment to height in cooperation with the fixed concave part 22. The nut 26 can adjust the height in a case that the screw 21 screws to the following direction, and the height is raised up when the screw 21 is rotated to the opposite direction. Since the nut 26 can rotate because of the ball part of the nut, the screw 28 presses and fixes at the preferred position.

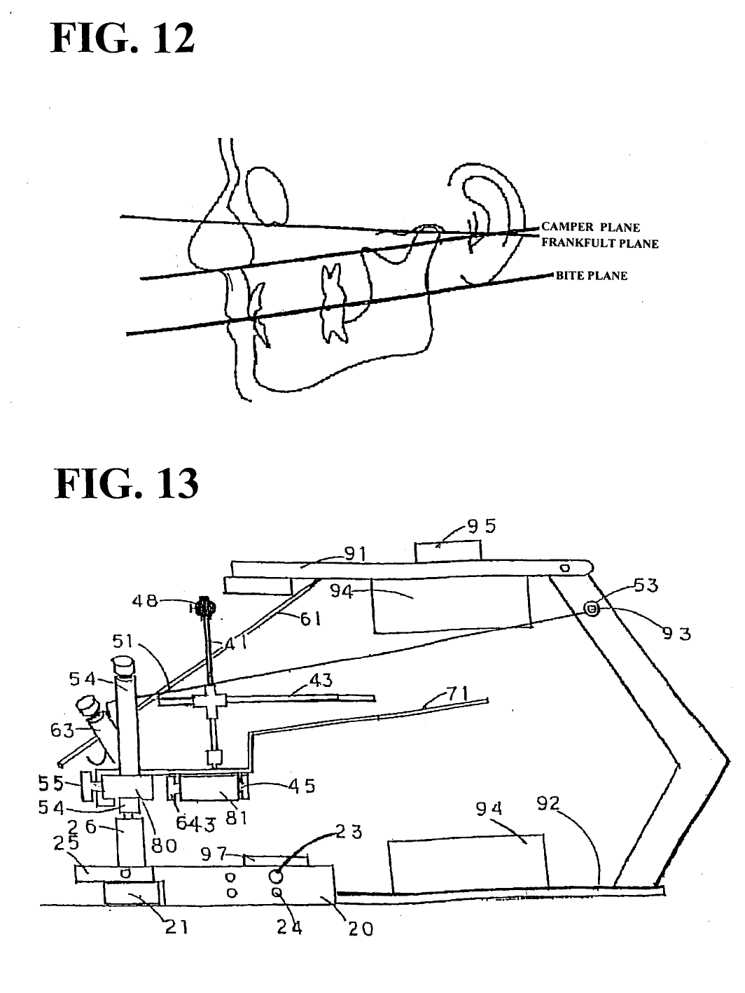

FIG. 12 illustrates a diagram for measuring side parts of the main points of patient's face. The patient's face is taken to provide the prosthetic dentistry object for patient from dentist. Main points which measure the patient's face is shown in the side view. The main points are frankfult plane F, camper plane C and bite plane O.

FIG. 13 is a side view showing the way in which an articulation-navigation equipment for dental surgery which is fixed via a fixing base, shown in FIG. 10, installed in a bite device.

After the articulation-navigation equipment 100 for dental surgery which is taken the patient's face is fixed to the fixing base 20, it is installed in the bite device. Then the prosthetic dentistry object is manufactured. It is easy to manufacture the aesthetic and functional prosthetic dentistry object because the face is observed by the bite device. It is a side view showing the way in which the articulation-navigation equipment 100 for dental surgery includes the fixing base 20 fixed to the bite device having an upper bow 91, a lower bow 92, the location pin 93, a mount ring 94 and a fixation screw 95 for the mount ring. Median line M on the model is shown in the position of the pointing rod 41 for the median line. The bite plane O on the model is shown in the pointing rod 43 for bite plane. One of orbital on the model is shown in the position of the orbital pointing pin 61. The right and left orbital on the frankfult plane F on the model is shown in the position of the orbital point 421. The camper plane C on the model is shown in the position of the positioning wire 51 for camper which extends from the fixing ring 53 fixed to the location pin 93. The positioning wire 51 for camper is screwed on the fixing shaft 54.

The member of the articulation-navigation equipment 100 for dental surgery is mainly formed of aluminum alloy, titanium alloy or plastic with intensity. A wire which is twisted and bundled the metal thin line etc. or nylon string is used for positioning wire 51 for camper. In addition, iron or stainless steel etc. which performed rust processing may be used without lightweight.

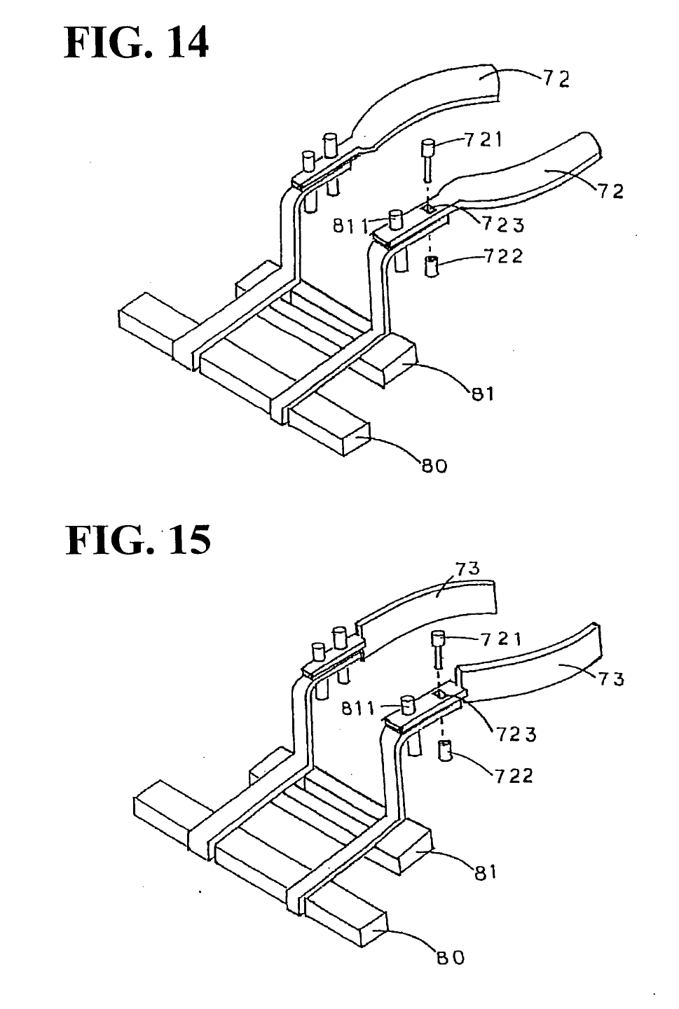

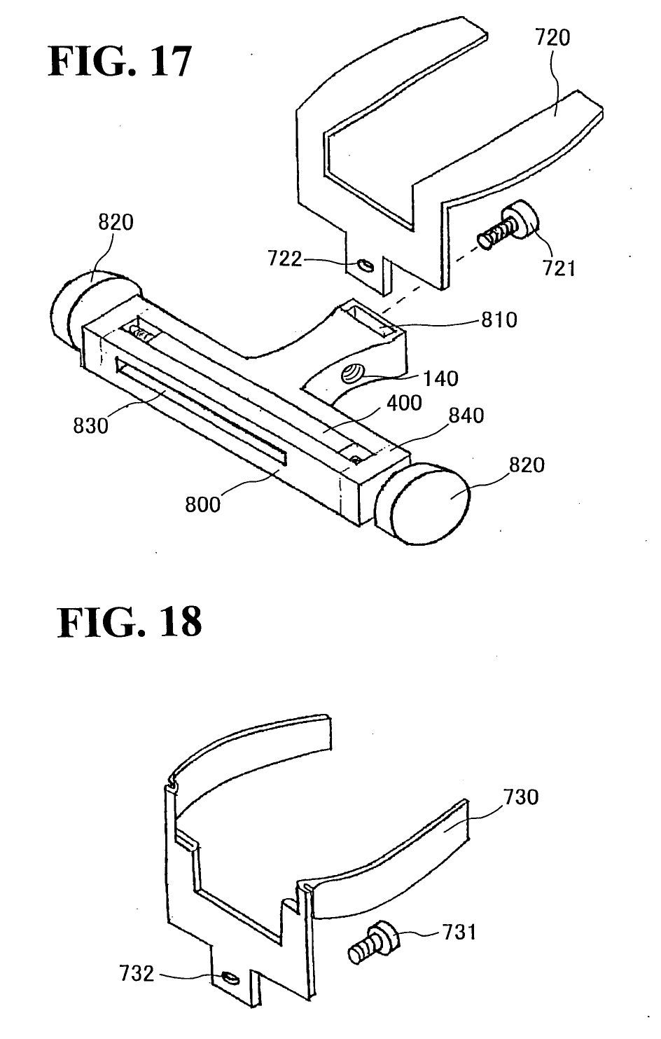

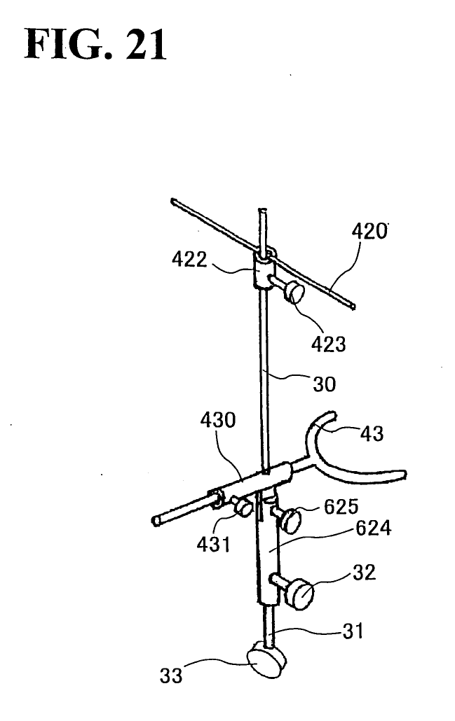

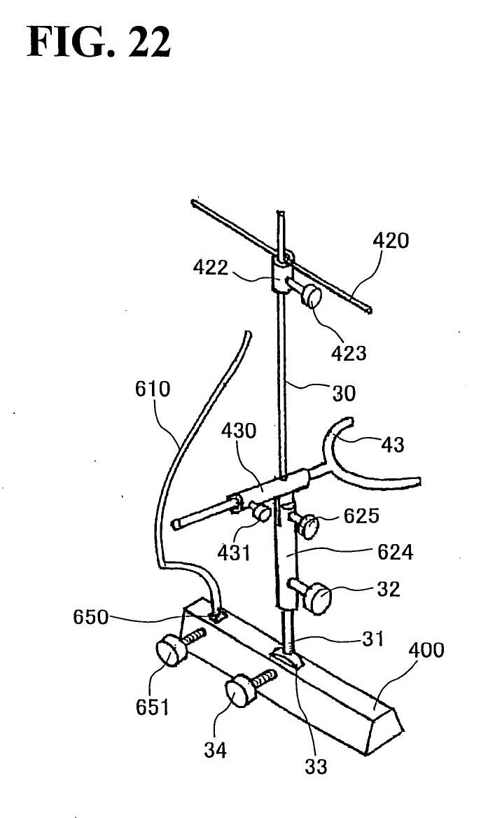

Other embodiments of the present invention will now be described referring to FIGS. 14 to 30. Through the drawings of the embodiments, like components are denoted by like numerals as of the first embodiment and will not be further explained in great detail.

A second embodiment of the present invention is shown in FIG. 14 and is distinguished from the first embodiment by the fact that the bite fork in the articulation-navigation equipment 100 for dental surgery is provided detachably, and the bite forks 72 are exchanged whenever the patient changes for hospital infection prevention since the saliva and blood of patient adhere when the patient bites.

FIG. 14 illustrates a perspective view of a bite fork which screws in a support shaft (the figures of the other measuring parts are omitted).

The bite fork 72 is supported by the support shaft which is attached detachably by screws 721, 811. The bite forks 72 include the screw 721, a nut 722 inserted the screw 721 therein and a screw hole 723 which is formed in the shape of rectangle, capable of fine adjusting to the horizontal direction so as to fine adjust the direction on the support shaft. The shape of the bite fork 72 has large size (L), middle size (m) and small size (S), corresponding to the oral cavity of the patient. The support shaft of the bite fork 72 is fixed to the support bases 80, 81. When the bite fork 72 is used, the modeling compound is applied to both sides of the bite fork 72 so as to remain the teeth mark of the patient.

A third embodiment of the present invention is shown in FIG. 15 and is distinguished from the first embodiment by the fact that pressing plates for tooth alignment (bite spoon) 73 one of the measuring parts are provided at right and left side detachably for the articulation-navigation equipment 100 for dental surgery. For hospital infection prevention, the bite spoon 73 for patient is exchanged whenever the patient changes.

FIG. 15 illustrates a perspective view of a bite spoon which screws in a support shaft (the figures of the other measuring parts are omitted).

The bite spoon 73 is supported by the support shaft which is attached detachably by the screw 721, 811. The bite spoon 73 includes the screw 721, nut 722 inserted the screw 721 therein and a screw hole 723 which is formed in the shape of rectangle, capable of fine adjusting to the horizontal direction so as to fine adjust the direction on the support shaft. The shape of the bite spoon 73 has large size (L), middle size (m) and small size (S), corresponding to the oral cavity of the patient. The support shaft of the bite spoon 73 is fixed to the support bases 80, 81. When the bite spoon 73 is used, the modeling compound is applied to an inner part of the bite spoon 73 so as to remain the side of the teeth mark of the patient.

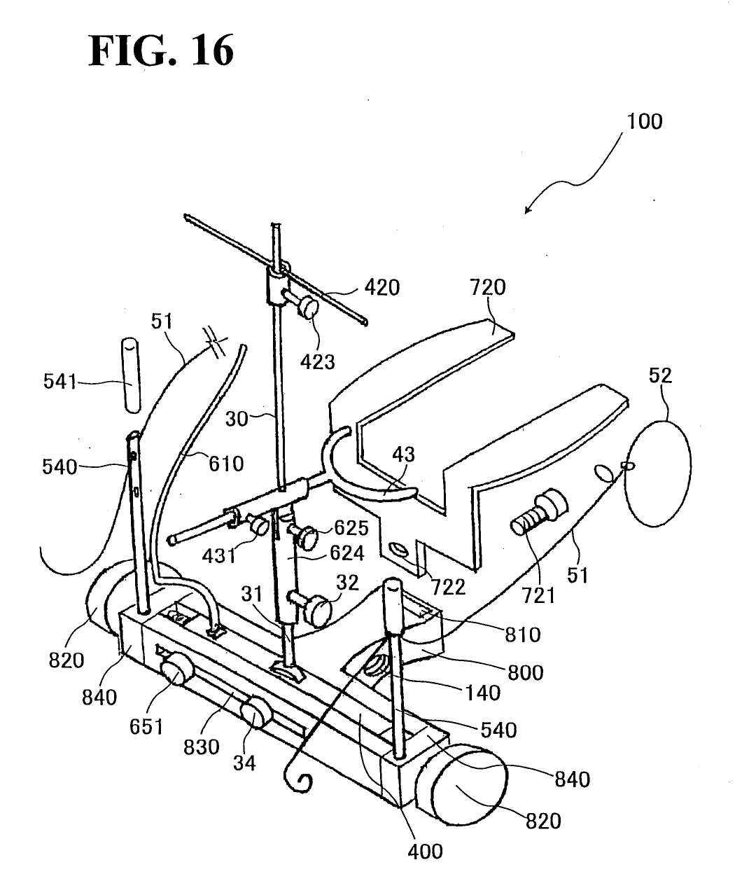

A fourth embodiment of the present invention is shown in FIGS. 16 to 25 and is distinguished from the first embodiment by the fact that the step of the measuring operation of the dentist is decreased. The support bases 80, 81 with the measuring parts are unified a support base 800. The bite fork 720 or bite spoon 730 is provided detachably by only one screw. When the positioning wire 51 for camper is fixed, it passes through the hole of the fixing shaft 540 without the screw, and a cap 541 for fixation covers on. The mechanism to measure and take the patient's median line easily and with ultra-precision is provided at the support base 800, the support base 400. In addition, when the prosthetic dentistry object is manufactured by the bite device with the articulation-navigation equipment for dental surgery of the present invention, a holding stand 11 may be used, installing in various kind of the bite device, and supporting the manufacturing the prosthetic dentistry object.

The bite fork 720, one of the measuring parts, fixed the bite plane after it is inserted in the oral cavity and bitted as shown in FIGS. 16 to 18 is formed integrally, having a tip portion thereof provided detachably and having the screw hole 722. The tip portion of the bite fork 720 is inserted into an attachment part 810 provided at the support base 800, and the screw 721 is screwed into the screw hole 722 fixedly. In addition, the bite spoon 730 has the same elements mentioned above. The screw 731 is screwed into the screw hole 732 fixedly. The moving support base 400 which is formed in the shape of a trapezoid is provided at a space which is hollowed out the support base 800 so as to move in that space of the support base 800. The support base 400 moves properly and slidably by operating screws 820, and it is fixed as the required point. The support base 800 includes a screw hole 140 for holding, capable of screwing the holding rod 18 of the holding stand 11; and a concave part 830 for the inclination part which is screwed the screw 34 and a screw 651. The fixation part 840 with the screw 820 is provided fixedly support bases 800 at right and left side thereof.

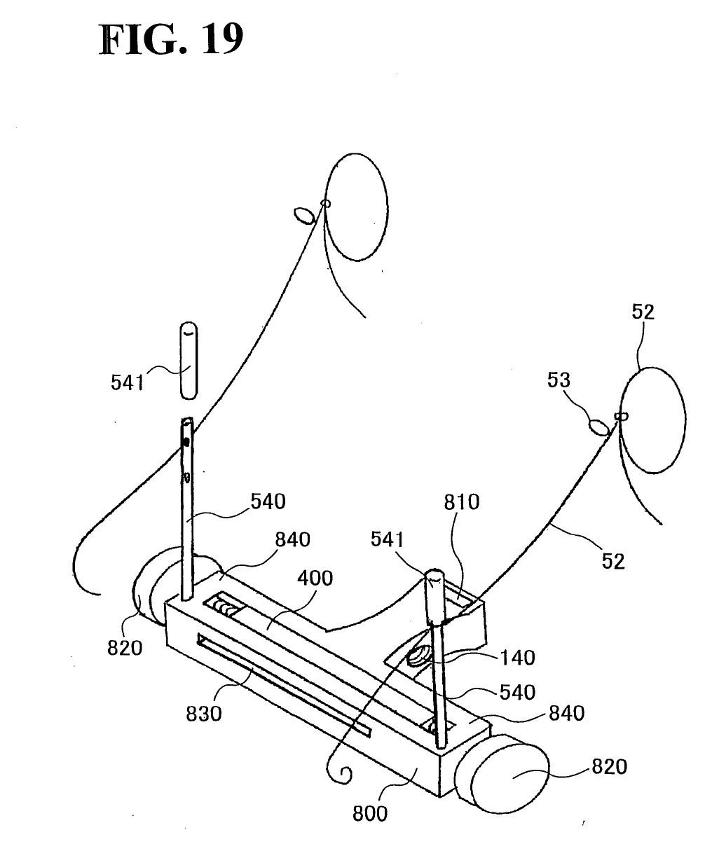

As shown in FIG. 19, fixing shaft 540 is attached to the fixation part 840, having a plurality of holes which are passed through the positioning wire 51 for camper. After the positioning wire 51 for camper is passed through the holes of the fixing shaft 540, caps 541 for fixation covers on the fixing shaft 540 fixedly.

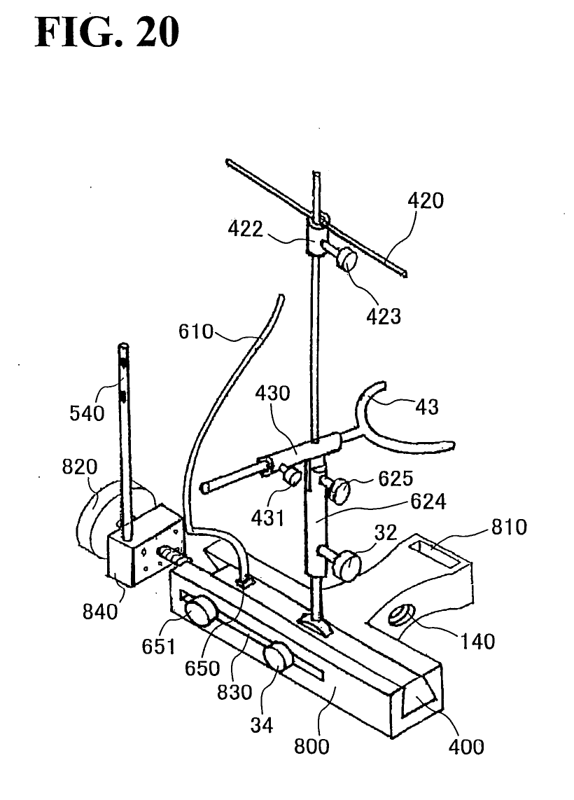

As shown in FIGS. 20 to 22, an orbital pointing pin 610 is supported by the inclination part 650 which inclines so as to support. The inclination part 650 is screwed the screw 651 and fixed the position.

The orbital pointing pin 610 supports one point of the bite device when the articulation-navigation equipment 100 for dental surgery is attached to the bite device and the prosthetic dentistry object is manufactured.

In addition, a support pipe 624 supports the pointing rod 420 for the frankfult plane F, pointing rod 30 for median line M and pointing rod 43 for bite plane O. The pointing rod 30 is supported by the inclination part 33 which supports a support pole 31, inclining to the horizontal direction. The position of the inclination part 33 is determined by the screw 34.

Furthermore, when the support pipe 624 moves vertically, the screw 32 is screwed down. When the support rod 30 and pointing rod 43 moves anteroposteriorly, the screw 625 is screwed down. When the pointing rod 420 moves vertically, the screw 423 is screwed down.

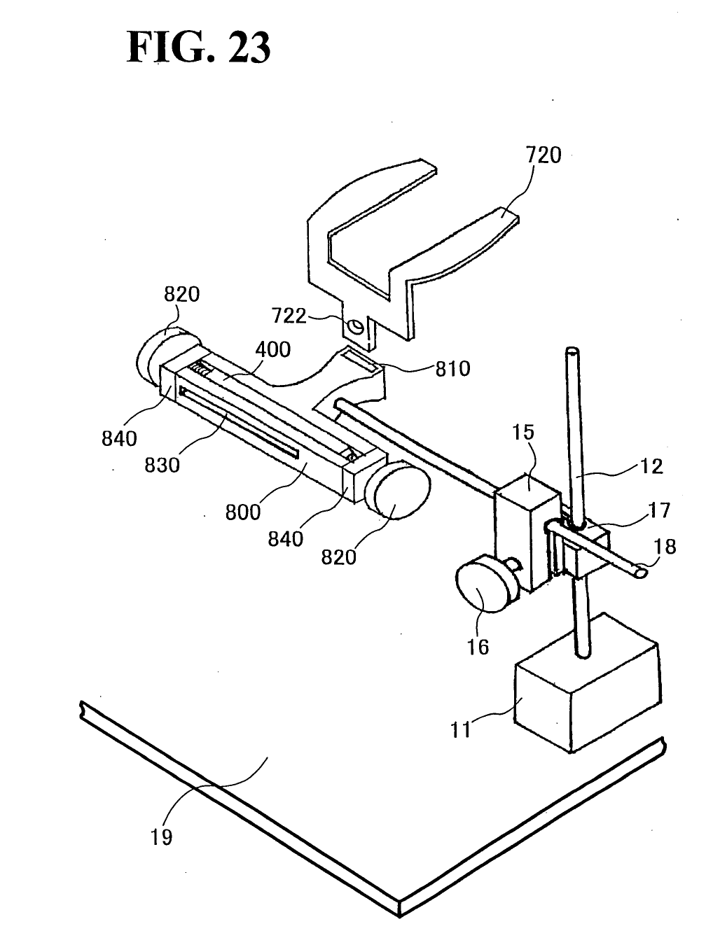

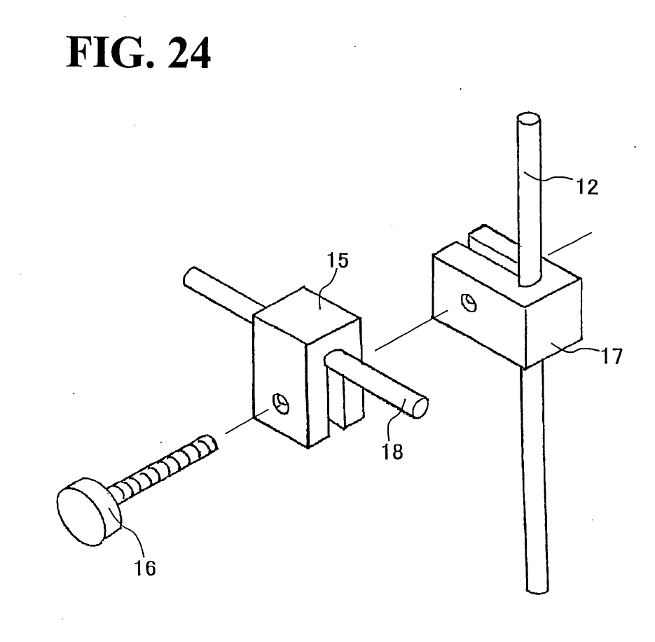

As shown in FIGS. 23 and 24, when the artificial teeth as the prosthetic dentistry object is manufactured in the case that articulation-navigation equipment 100 for dental surgery of the present invention is installed in the bite device, the holding stand 11 is used so as to manufacture the correct the prosthetic dentistry object, capable of installing in the various kind of the bite device. The holding stand 11 is formed of metal material, and the back thereof is embedded a strong magnet. A support rod 12 and holding rod 18 is formed of metal material. The support rod 12 and holding rod 18 are attached by the screw 16 via the holding rod holding part 15. For determining the position, when the screw 16 is screwed down, the support rod 12 and holding rod 18 move freely. The screw of the holding rod 14 is screwed in the screw hole 140 for holding of the support base 800. A base 19 is made of metal material, the magnet of the holding stand 11 can support the support base 800 suitably.

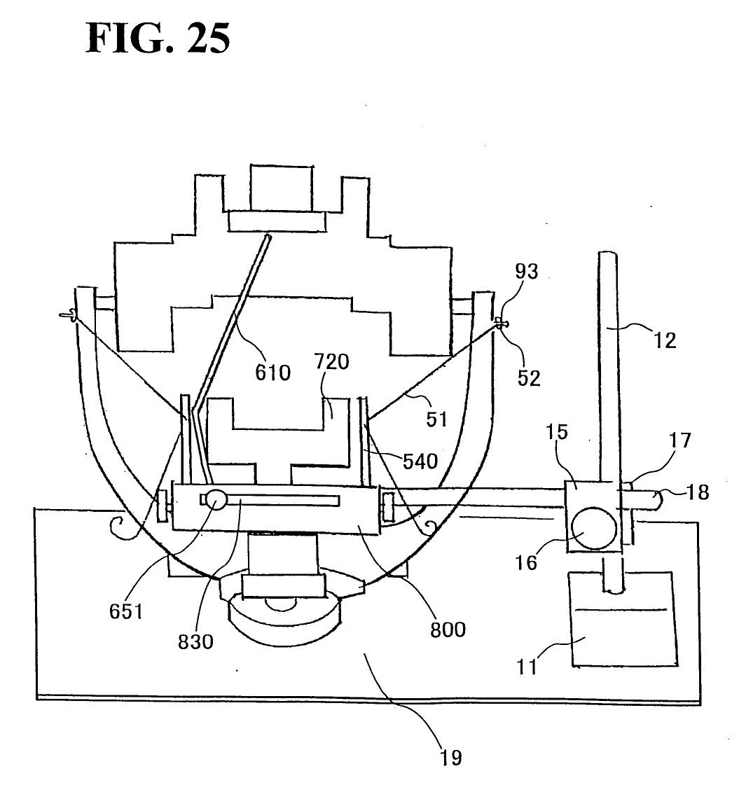

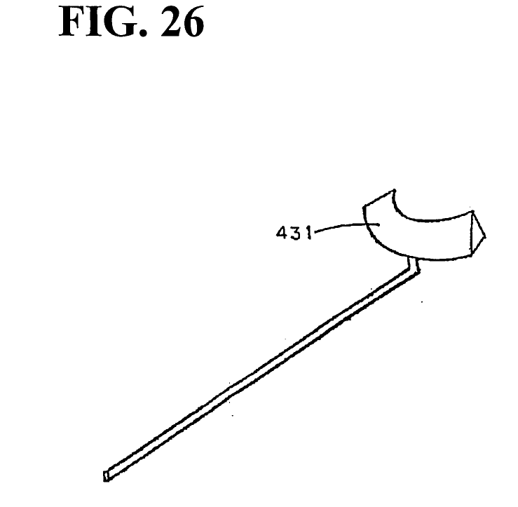

FIG. 25 illustrates a front view showing the way in which the articulation-navigation equipment 100 for dental surgery is attached to the bite device.

The support base 800 of the articulation-navigation equipment 100 for dental surgery is supported by the holding rod 18. The holding rod 18 is screwed fixedly by the screw 16 via the holding part 15, and the support rod 12 is screwed fixedly by the screw 16 via the holding part 17 for the support rod. Therefore, the holding part 17 holds the support rod 12, and the support rod 12 is screwed on the holding stand 11.

After the fixing ring 53 of the positioning wire 51 for camper is attached fixedly to the location pin 93 of the bite device, one of the fixing rings 53 is fixed to the fixing shaft 540 of the support base 800. The orbital pointing pin 610 helps to manufacture by supporting one point of the bite device when the articulation-navigation equipment 100 for dental surgery is attached to the bite device, and the prosthetic dentistry object is manufactured.

For manufacturing the prosthetic dentistry object, after the articulation-navigation equipment 100 for dental surgery is attached to the bite device, it starts to manufacture after the observation is carried out squarely. When the manufacture is started, the basic point of the patient is taken shape by the support rod 30 for median line and the like. Since the manufacturing starts after the screw 34 is screwed down, it is comfortable to manufacture.

For hospital infection prevention, the bite fork 720, bite spoon 730 and positioning wires 51 for camper are exchanged whenever the patient changes, and medical abandonment is performed.

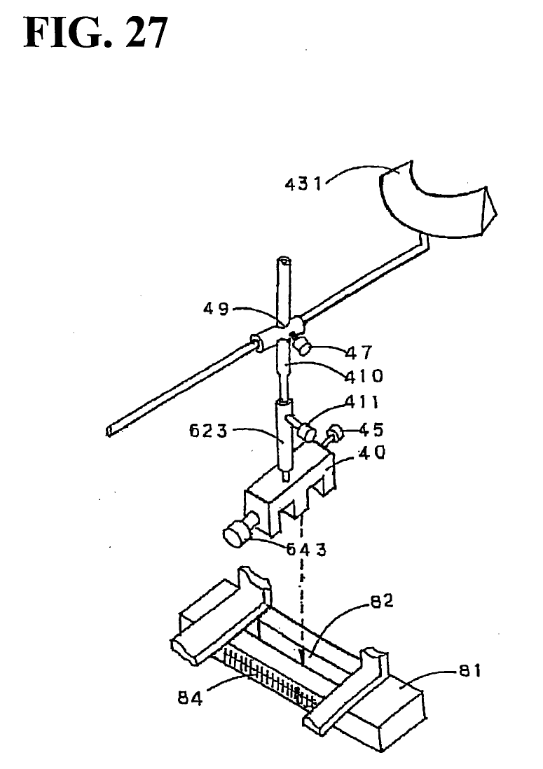

A fifth embodiment of the present invention is shown in FIGS. 26 and 27 and is distinguished from the first embodiment by the fact that a front teeth arrangement plate 431 for prosthetic tooth is used, capable of using the pointing rod 43 for bite plane with adjusting the screw 47 in combination with the articulation-navigation equipment 100 for dental surgery, supported by the holding part 49 for the bite plane and fixed by the screw 47. As shown in FIG. 26, the prosthetic tooth arrangement plate 431 for front teeth includes a suitable inclination which three teeth as front teeth-prosthetic tooth of the upper jaw can be adhered by wax centering around the patient's median line M, having a curvature part corresponding to the curvature of the patient's front teeth of the upper jaw. The curvature part has the supported rod so as to support by the holding part 49 for the bite plane. The pointing rod 43 for the bite plane supported by the pointing rod 41 for median line which measures the median line M and holding part 49 for bite plane which measures the bite plane and fixed by the screw 47 is used with adjusting the screw 47, and the prosthetic tooth arrangement plate 431 for front teeth has a large size (L), middle size (m) and small size (S) so as to correspond to the curvature portion of the patient's front teeth of the upper jaw.

FIG. 27 illustrates a perspective view of the holding part for bite plane which supports the front teeth arrangement plate for prosthetic tooth.

The supported rod of the prosthetic tooth arrangement plate 431 for front teeth passes through the holding part 49 for bite plane and is fixed by the screw 47. The holding part 49 for the bite plane attaches to the support pole 410, the support pole 410 inserts the support pipe 623 and is fixed by the screw 411 so as to move upward and downward. One of the support pipe 623 is formed in the shape of a ball, and it is engaged with the support base 40. Because one end of the support pipe 623 is formed in the ball shape, the support pipe 623 may be inclined. The support pipe 623 is fixed by the screw 45 at the inclined position. The backside of the support base 40 is formed in the shape of a mountain, and the back of the support base 40 engages with the concave part 82 of the support base 81 and moves slidably. The support base 40 is fixed by the screw 643 at a pre-positioned state. The graduation 84 is attached to the side face of the support base 81, then the position of the support base 40 is known by the graduation 84. The graduation 84 is needed when a bite plane plate 432 for molar teeth and prosthetic tooth is replaced from the pointing rod 43 for the bite plane. In addition, if the graduation 84 of the support base 40 is recorded and noticed when dentist gives the articulation-navigation equipment for dental surgery to dental technician (material flow), the support base 40 is worked off the support base 81, and it can be sent with small size.

When the prosthetic tooth arrangement plate 431 for front teeth is used, dentist confirms the position and degree based on the basic point and position to the patient's cranium and face with the prosthetic tooth arrangement plate 431 for front teeth in the case that the patient's cranium and face is measured and recorded and the median line M is decided. Therefore, the arrangement of the front teeth prosthetic tooth as requested by the patient is carried out in view of aesthetic functional point

After main points in the patient's cranium and face are measured and taken by the articulation-navigation equipment 100 for dental surgery by dentist, the front teeth arrangement plate 431 for prosthetic tooth is used in combination with the articulation-navigation equipment 100 for dental surgery. Since the articulation-navigation equipment 100 for dental surgery is recorded the patient's median line M, the size, shape and material of the front teeth corresponding to the patient are decided. The position of the left central incisor and right central incisor based on the median line M is decided from the samples of various kind of teeth, size, color and material. Therefore, it benefits aesthetically and functionally.

For the recorded articulation-navigation equipment 100 for dental surgery, the used prosthetic tooth arrangement plate 431 for front teeth is given to the dental technician after the kind of the prosthetic tooth of the central incisor based on the median line M. The dental technician receives the front teeth arrangement plate for prosthetic tooth 431 and articulation-navigation equipment 100 for dental surgery, and the arrangement of the prosthetic tooth of the upper jaw and front teeth is carried out to the biteplate according to the arrangement of the upper jaw front teeth prosthetic tooth.

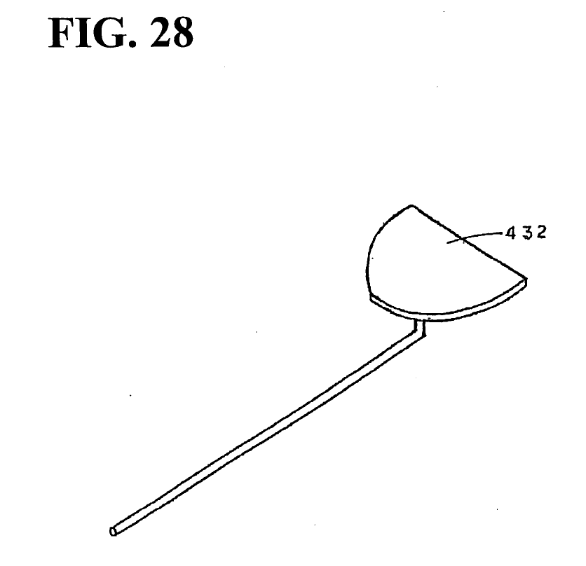

A sixth embodiment of the present invention is shown in FIGS. 28 to 30 and is distinguished from the fifth embodiment by the fact that a front teeth arrangement plate 432 for prosthetic tooth is used, capable of using bite plane pointing rod 43 with adjusting the screw 47 in combination with the articulation-navigation equipment 100 for dental surgery, supported by the holding part 49 for the bite plane and fixed by the screw 47. The bite plane plate 432 for molar teeth and prosthetic tooth is installed so as to arrange teeth on the plane plate 432 so as to be able to arrange the molar teeth-prosthetic tooth of the patient's front teeth of the upper jaw based on the arrangement of the front teeth-prosthetic tooth after the front teeth-prosthetic tooth is arranged centering around the patient's median line M by the front teeth of the upper jaw in the biteplate on plaster cast in order to decide the position of the front teeth of the upper jaw. In the bite plane plate 432 for molar teeth and prosthetic tooth, the pointing rod 43 for bite plane is supported by the pointing rod 41 for median line which measures the median line M and bite plane holding part 49 which measures the bite plane and fixed by the screw 47 is used with adjusting the screw 47 so that the supported rod is installed in the bite plane plate 432 for molar teeth and prosthetic tooth. The bite plane plate 432 for molar teeth and prosthetic tooth has large size (L), middle size (m) and small size (S), corresponding to the oral cavity of the patient.

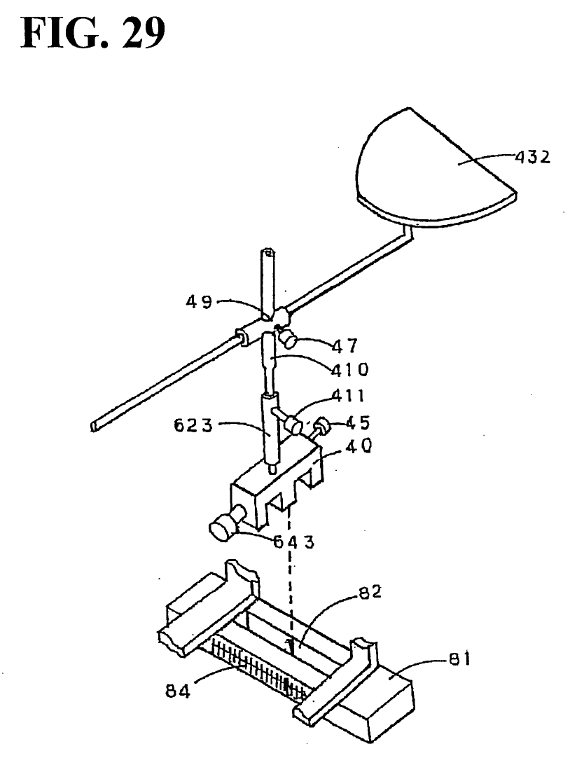

FIG. 29 illustrates a perspective view of the holding part for bite plane which supports bite plane plate for the molar teeth-prosthetic tooth.

The supported rod of the bite plane plate 432 for molar teeth and prosthetic tooth passes through the holding part 49 for bite plane and is fixed by the screw 47. The holding part 49 for the bite plane attaches to the support pole 410, the support pole 410 is inserted the support pipe 623 and is fixed by the screw 411 so as to move upward and downward. One end of the support pipe 623 is formed in the shape of a ball, and it engaged with the support base 40. Because one of the support pipe 623 is formed in the ball shape, the support pipe 623 may be inclined. The support pipe 623 is fixed by the screw 45 at the inclined position. The backside of the support base 40 is formed in the shape of a mountain, and the back of the support base 40 engages with the concave part 82 of the support base 81 and moves slidably. The support base 40 is fixed by the screw 643 at a pre-positioned state. The graduation 84 is attached to the side face of the support base 81, then the position of the support base 40 is known by the graduation 84. The graduation 84 is needed when the bite plane plate 432 for molar teeth and prosthetic tooth is replaced from the pointing rod 43 for the bite plane. In addition, if the graduation 84 of the support base 40 is recorded and noticed when dentist gives the articulation-navigation equipment for dental surgery to dental technician (material flow), the support base 40 is worked off the support base 81, and it can be sent with small size. When the support base 40 is restored, it can be restored actually since the graduation 84 is noticed.

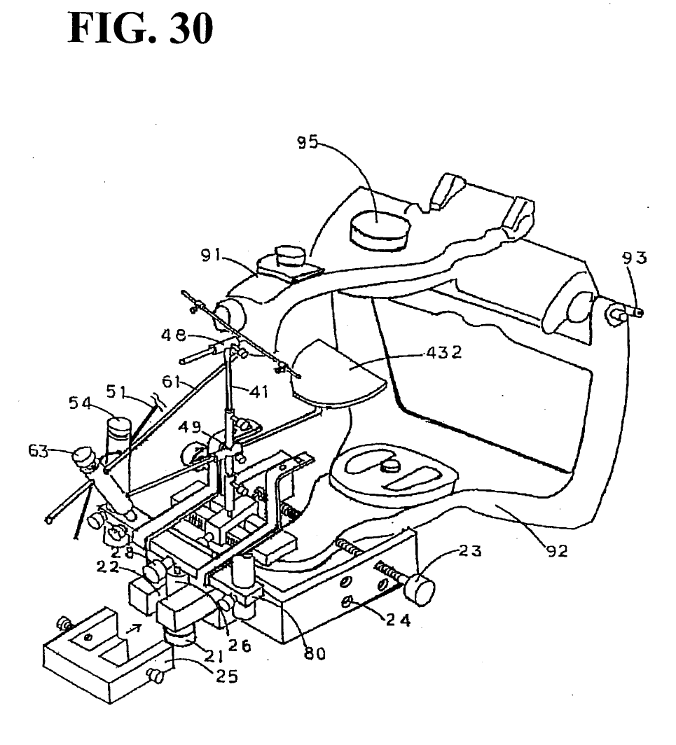

FIG. 30 illustrates a cutaway perspective view showing the way in which the bite plane plate 432 for molar teeth and prosthetic tooth with the articulation-navigation equipment for dental surgery is installed in the bite device by the fixing base.

The figure shown the bite plate which is attached to the bite device is omitted. It illustrates a perspective view showing the way in which the bite plane plate 432 for molar teeth and prosthetic tooth with the articulation-navigation equipment 100 for dental surgery is installed in the bite device by the fixing base 20. When the articulation-navigation equipment 100 for dental surgery is attached to the bite device, the fixing base 20 selects the pair of the screw 23 for fixation and screw hole 24 depending on the shape of the bite device. The aesthetic and functional arrangement of the molar teeth-prosthetic tooth is carried out by demanding the aesthetic balance by the patient's cranium, face and facial features after the bite device is installed. In addition, when the fixing base 20 s magnetized, it put the metal plate on the work stand. The explanation about bite device is omitted the name of the parts in figures because the bite plane plate 432 for molar teeth and prosthetic tooth with the articulation-navigation equipment 100 for dental surgery is installed in the bite device by using the fixing base 20 and its appearance is the same as the side view mentioned above.

In addition, the material of the articulation-navigation equipment 100 for dental surgery, the prosthetic tooth arrangement plate 431 for front teeth and the bite plane plate 432 for molar teeth and prosthetic tooth are used preferably lightweight member and mainly uses aluminum alloy, titanium alloy or plastic with intensity. A wire which is twisted and bundled the metal thin line etc. or nylon string is used for positioning wire 51 for camper.

Moreover, iron or stainless steel etc. which performed rust processing is used when lightweight is a main purpose. In order to hold and fix powerfully, the fixing base 20 may be magnetized using the material of the iron or nickel which carried out rust processing or cobalt which are a ferromagnetic substance.

In addition, for hospital infection prevention, the prosthetic tooth arrangement plate 431 for front teeth and bite plane plate 432 for molar teeth and prosthetic tooth are exchanged whenever the patient changes, and medical abandonment is performed.

As set forth above, the advantages of the invention are as follows:

(1) Since the present invention includes the measuring parts which take basically the relation between the patient's face and teeth are arranged; right and left bite fork which is bite in the oral cavity of the patient and fixes the bite plane; a positioning wire for camper, extending to right and left ears which measures and takes the camper plane C; an orbital pointing pin which measures and takes one of orbital; a pointing rod for median line which measures and takes the median line M; orbital points which measures and takes the right and left orbital on the frankfult plane F; pointing rod for bite plane which measures and takes the bite plane O; screw which is screwed on the nut for adjusting the height, supporting the support base; and screw for fixation. Therefore, it can operate quickly in a short time in spite of the face bow without practice and can manufacture the aesthetic and functional prosthetic dentistry object easily.

(2) As discussed above, the dental technician who manufactures the prosthetic dentistry object can decide median line, right and left orbital, one of orbital, frankfult plane, camper plane and bite plane physically on the model that the taken articulation-navigation equipment for dental surgery is attached without covering by the measuring parts of the articulation-navigation equipment for dental surgery. In addition, the support base can be removed so that it is easy to transfer.

(3) As discussed above, since the bite fork or bite spoon for patient can be changed t new one whenever the patient uses, the patient feel clean, and it can be prevented the hospital infection. In addition, the bite fork or bite spoon has a large size, middle size or small size corresponding to the size of the oral cavity so that the actual bite shape can be measured and taken.

Therefore, the articulation-navigation equipment for dental surgery is fixed to the fixing base and installed in the bite device so that it is easy to manufacture the aesthetic and functional prosthetic dentistry object.

(4) Claims 2 to 10 achieve the same effect of the above-mentioned (1) to (3).

(5) Claim 11 achieves the same effect of the above-mentioned (1) to (3), and the median line as the basis on the arrangement of the front teeth-prosthetic tooth by dentist is measured by the articulation-navigation equipment for dental surgery, and the bite plane is fixed by the bite plane pointing rod. Therefore, the median line is already determined and the front teeth arrangement plate for prosthetic tooth is only changed. The front teeth arrangement plate includes a suitable inclination which three teeth as front teeth-prosthetic tooth of the upper jaw can be adhered by a wax centering around the patient's median line, having a curvature part corresponding to the curvature of the patient's front teeth of the upper jaw so that the front teeth arrangement plate for prosthetic tooth passes through the bite plane holding part and is fixed by the screw, and the center position of the arrangement of the front teeth-prosthetic tooth is already determined. Therefore, the front teeth arrangement plate attaches to the curvature part of the front teeth for the arrangement of the front teeth-prosthetic tooth, and the dentist or dental technician can work to arrange the bite with considering the size, color and material of the prosthetic tooth and decide to arrange the suitable front teeth-prosthetic tooth by the facial features of the patient.

(6) As discussed above (5), the front teeth arrangement plate is formed with the large size (L), middle size (m) and small size (S) so as to correspond to the curvature portion of the patient's front teeth so that dentist or dental technician can be chosen the suitable size for the arrangement of the patient's front teeth prosthetic tooth, and it can be improved to provide medical care efficiently.

(7) Claim 12 achieves the same effect of the above-mentioned (1) to (3), and the dentist or dental technician can work to arrange the bite with considering the size, color and material of the prosthetic tooth when the arrangement of the molar teeth-prosthetic tooth of the upper jaw is determined on the basis of the prosthetic arrangement for the front teeth of the upper jaw decided by front teeth arrangement plate after the bite plane plate with the articulation-navigation equipment is installed in the fixing base. Therefore, it can be operated in a short time n the best condition.

(8) As discussed above (7), the bite plane for the molar teeth-prosthetic tooth is formed with the large size (L), middle size (m) and small size (S) so as to correspond to the curvature portion of the patient's front teeth so that dentist or dental technician can be chosen the suitable size for the arrangement of the patient's front teeth prosthetic tooth, and it can be improved to provide medical care efficiently.

### INDUSTRIAL APPLICABILITY

The present invention is used in the industry which manufactures and sells the articulation-navigation equipment for dental surgery, and it is used by dentist, dental technician, etc.

1. An articulation-navigation equipment for dental surgery, capable of operating quickly in a short time in spite of a face bow without practice and manufacturing the aesthetic and functional prosthetic dentistry object easily, comprising:
measuring parts which take basically the relation between the patient's face and teeth are arranged;
bite forks which is bite in the oral cavity of the patient and fixes the bite plane;
a positioning wire for camper, extending to right and left ears which measures and takes the camper plane;
an orbital pointing pin which measures and takes one of orbital;
a pointing rod for median line which measures and takes a median line;
orbital points which measures and takes the right and left orbital on the frankfult It plane;
a pointing rod for bite plane which measures and takes a bite plane;
a screw which is screwed on a nut for adjusting the height, supporting a support base; and
a screw for fixation of the nut.

2. An articulation-navigation equipment for dental surgery according to claim 1, further comprising:
the bite forks as one of the measuring parts, providing at a support shaft integrally, having a large size, middle size and small size corresponding to the size of the oral cavity of the patient, and applying a modeling compound to both sides of the bite fork to remain the teeth mark of the patient when the bite forks are used; and
the support shaft attached fixedly to a support base and a support base.

3. An articulation-navigation equipment for dental surgery according to claim 1, further comprising:
detachable bite forks as one of the measuring parts provided at right and left sides, exchanging the bite fork whenever the patient changes for hospital infection prevention, the bite forks supported by the support shaft which is attached detachably by screws, further including
a nut which is formed at the bite forks, inserting the screw therein, and a screw hole which is formed in the shape of rectangle, capable of fine adjusting to the horizontal direction so as to fine adjust the direction on the support shaft;
the bite forks having the large size, middle size and small size, corresponding to the oral cavity of the patient and applying a modeling compound to both sides of the bite fork to remain the teeth mark of the patient when the bite forks are used; and
the support shaft which is attached fixedly to the support bases.

4. An articulation-navigation equipment for dental surgery according to claim 1, further comprising:
detachable bite spoon as one of the measuring parts provided at right and left sides, exchanging the bite spoon whenever the patient changes for hospital infection prevention, the bite spoon supported by the support shaft which is attached detachably by the screws, further including
the nut which is formed at the bite spoon, inserting the screw therein, and the screw hole which is formed in the shape of rectangle, capable of fine adjusting to the horizontal direction so as to fine adjust the direction on the support shaft;
the bite spoon having the large size, middle size and small size, corresponding to the oral cavity of the patient and applying a modeling compound to both sides of the bite spoon to remain the teeth mark of the patient when the bite spoon are used; and
the support shaft which is attached fixedly to the support bases.

5. An articulation-navigation equipment for dental surgery according to any of claims 1 to 4, further comprising:
a positioning wire for camper which measures and takes camper plane as one of the measuring parts;
a plurality of fixing shafts which fixes the positioning wire for camper and the positioning wire for camper which are provided at the right and left sides of the support base, the fixing shaft passing through the support base and installing to move upward and downward, and fixing by screws which are provided the same number of the fixing shaft at the support base;
tip portions of the right and left positioning wires for camper including hanging rings which hangs the ears and fixing rings; and
the fixing ring is provided at a place which hangs to a location pin of the bite device when the prosthetic dentistry object is manufactured, one of the positioning wires for camper being fixed by the screw via a hole which is provided at the fixing shaft.

6. An articulation-navigation equipment for dental surgery according to any of claims 1 to 4, further comprising:
an orbital pointing pin as one of the measuring parts which is installed fixedly by a screw which passes through the hole of an orbital point shaft, measuring and taking one of the orbital, having one end of the orbital point shaft which is formed in the shape of a ball so as to support rotatably in the orbital range;
an engagement part which is formed at the support base, capable of engaging the ball part of the orbital point shaft therewith; and
a screw which fixes the ball part which is engaged with the engagement part at a predetermined position in the orbital range.

7. An articulation-navigation equipment for dental surgery according to any of claims 1 to 4, further comprising:
a pointing rod for median line, right and left orbital points and a pointing rod for bite plane as the measuring parts which are installed;
the pointing rod for bite plane which passes through a holding part for the bite plane which is formed in the shape of a cross and tube and is fixed by the screw;
the holding part for the bite plane which is supported fixedly by a support pole which is inserted into the a support pipe and is fixed by a screw;
the support pipe having a ball part at one side thereof engaging with the support base;
a screw which fixes the support pipe at a inclined position;
the support base having a backside thereof which is formed in the shape of a mountain so as to engage and move slidably;
a concave part which is formed at a support base;
a graduation which is formed at the support base, pointing to the position; and
a screw which fixes the support base with the support base at a determined position.

8. An articulation-navigation equipment for dental surgery according to any of claims 1 to 4, further comprising:
a pointing rod for median line, right and left orbital points and a pointing rod for bite plane as the measuring parts which are installed;
the pointing rod for median line which passes through an upper part of the holding part for the bite plane which is formed in the shape of a cross and tube and is fixed by the screw;
the holding part for the bite plane which is supported fixedly by a support pole at a lower part thereof;
the screw which adjusts and fixes the upward and downward movement of the pointing rod;
the screw which adjusts and fixes the inclination of the pointing rod for median line; and
a screw which adjusts the horizontal movement of the pointing rod to be moved the support base.

9. An articulation-navigation equipment for dental surgery according to any of claims 1 to 4, further comprising:
the pointing rod for median line, the right and left orbital points and the pointing rod for bite plane as the measuring parts which are installed;
the orbital points which further includes a screw so as to hold and fix with passing through the orbital pointing rod;
the orbital pointing rod which is held and fixed by a screw in the state that it passes through an orbital holding part which is formed in the shape of a T-letter and formed of a sleeve;
the orbital holding part which is supported by the support pole;
the holding part for the bite plane which supports the support pole which is fixed by the screw;
the screw which adjusts and fixes the upward and downward movement of the orbital point;
the screw which adjusts and fixes the inclination of the orbital point; and
the screw which adjusts the horizontal movement of the orbital point to be moved the support base.

10. An articulation-navigation equipment for dental surgery according to any of claims 1 to 4, further comprising:
a fixing base as the measuring parts which is used when the articulation-navigation equipment for dental surgery is supported fixedly and the taking state is confirmed or it is installed in the bite device, which is formed in the shape of a C-letter, further including a pair of screws for fixing; a plurality of screw holes which is formed corresponding to the shape of the bite device; a fixed concave part, capable of engaging fixedly the nut for adjustment to height of the articulation-navigation equipment for dental surgery and a fixed plug, which is formed in the shape of a mountain, fixing the nut for adjustment to height in cooperation with the fixed concave part.

11. An articulation-navigation equipment for dental surgery according to any of claims 1 to 4, further comprising:
a prosthetic tooth arrangement plate for front teeth as the measuring parts including a suitable inclination which three teeth as front teeth-prosthetic tooth of the upper jaw can be adhered by a wax centering around the patient's median line, having a curvature part corresponding to the curvature of the patient's front teeth of the upper jaw; a supported rod which supports the curvature part of the front teeth of the upper jaw, capable of using in spite of the pointing rod for the bite plane with exchanging, passing through the holding part for the bite plane and being fixed by the screw and having the large size, middle size and small size so as to correspond to the curvature portion of the patient's front teeth.

12. An articulation-navigation equipment for dental surgery according to any of claims 1 to 4, further comprising:
a bite plane plate for molar teeth and prosthetic tooth as the measuring parts which is installed, including a plane plate with the large size, middle size and small size corresponding to a biteplate of the oral cavity of the patient so as to be able to arrange the molar teeth-prosthetic tooth of the patient's front teeth of the upper jaw and a supported rod which supports the plane plate, capable of using in spite of one of the pointing rod and the front teeth arrangement plate for prosthetic tooth, passing through the holding part and being fixed by the screw; and
a biteplate with the prosthetic arrangement for the front teeth of the upper jaw, capable of arranging the bite of the molar teeth prosthetic tooth of the upper jaw thereto on the basis of the prosthetic arrangement for the front teeth of the upper jaw decided by front teeth arrangement plate after the bite plane plate with the articulation-navigation equipment is installed in the fixing base.
